(19) United States
(12) Patent Application Publication
(10) Pub. No.: US 2011/0079198 A1
(43) Pub. Date: Apr. 7, 2011

(54) INJECTION METHOD AND DEVICE FOR CONTROLLING AN INJECTION PROCESS IN AN INTERNAL COMBUSTION ENGINE

(76) Inventors: David MOESSNER, Lorch (DE); Axel Storch, Besigheim (DE); Wolfgang Boerkel, Benningen (DE); Harry Friedmann, Vaihingen An Der Enz (DE); Pierre-Yves Crepin, Stuttgart (DE)

(21) Appl. No.: 12/876,949

(22) Filed: Sep. 7, 2010

(30) Foreign Application Priority Data
Sep. 10, 2009 (DE) 102009029332.9
Jun. 7, 2010 (DE) 102010029728.3

(51) Int. Cl. F02M 69/04

(52) U.S. Cl. 123/445

(57) ABSTRACT

A method for controlling an injection of fuel in an internal combustion engine, in particular in a gasoline engine having direct injection, a drive fuel quantity, which indicates the fuel quantity required by the internal combustion engine to provide a torque, being injected in a working cycle before a combustion stroke of the working cycle into a cylinder of the internal combustion engine, a cooling fuel quantity, which indicates the fuel quantity which is used to cool the combustion exhaust gases, being injected in the working cycle in addition to the drive fuel quantity, at least part of the cooling fuel quantity being injected after completion of the combustion in the combustion stroke and/or the immediately following exhaust stroke of the working cycle.

### CROSS REFERENCE

The present application claims the benefit under 35 U.S.C. §119 of German Patent Application No. 102010029728.3 filed on Jun. 7, 2010 and German Patent Application No. 102009029332.9 filed on Sep. 10, 2009, each of which is expressly incorporated herein by reference in its entirety.

### FIELD OF THE INVENTION

The present invention relates to injection methods, in particular for internal combustion engines having direct fuel injection, and devices for controlling the injection of fuel into a combustion chamber of an internal combustion engine.

### BACKGROUND INFORMATION

In the case of internal combustion engines having direct fuel injection, in addition to a drive fuel quantity which is required for combustion, fuel is injected to cool the exhaust gas in the combustion chamber of the particular cylinder in a full-load range. The injection of this so-called cooling fuel quantity in high-load operation is referred to as enrichment and is used for the purpose of protecting the components situated in the exhaust system of the internal combustion engine, such as outlet valves, manifold, catalytic converter, and the like, from overheating. During operation of the internal combustion engine, the entire fuel quantity made up of drive fuel quantity and cooling fuel quantity are introduced within an injection time window in an intake stroke in the dimension of a crankshaft angle range of 150° to 200° before a compression stroke and subsequent ignition.

The fuel injectors for the direct injection of the fuel into the combustion chamber of the cylinder are typically designed having a static flow for a full-load operating point at a rated speed, for example, 6000 RPM, which corresponds to a rated power. In other words, the fuel injector is designed in such a way that a maximum required injection quantity to be injected before ignition, including the cooling fuel quantity, may be completely injected within the above-mentioned injection time window. In particular in the case of internal combustion engines having turbocharging, which require higher injection quantities, high required maximum flow values result here as the static flow.

On the other hand, in idle operation of the internal combustion engine and in catalytic converter heating operation, only very small fuel quantities, which must be set precisely in order to avoid noisy running, need to be injected. The metering range, i.e., the ratio between the greatest fuel quantity which is able to be metered and the smallest fuel quantity which is able to be metered, also referred to as the dynamic flow range (DFR), is very large. However, fuel injectors having a large metering range are complex to implement.

In particular, it is technically demanding in the case of fuel injectors which have a high static flow to ensure precise fuel metering in the case of low fuel quantities. In general, the particular metering range is nearly independent of the static flow in the case of typical fuel injectors of various constructions, i.e., in the event of large static flow, the smallest quantity which is able to be metered also rises. In the case of turbocharged internal combustion engines having a high degree of charging (high charging pressure), in which a high spread is required between the static flow rate and the minimum settable flow rate, this often results in problems in the case of metering of small fuel quantities. In particular, injecting an excessively high fuel quantity for torque generation may result in over-enrichment of the air/fuel mixture. In doing so, the fuel may not vaporize completely, so that burning liquid fuel will lead to increased carbon-black production.

A method for cylinder equalization of an internal combustion engine is described in German Patent Application No. DE 10 2007 020 964 A1, in which the individual cylinders are equalized in regard to their torque contribution to achieve the best possible smooth running. For this purpose, post-injection is provided in order to inject fuel into the cylinder in a torque-neutral manner, the post-injection being dimensioned in such a way that the exhaust gas corresponds to a stoichiometric air/fuel mixture.

### SUMMARY

It is an object of the present invention to provide a method for the activation of a fuel injector during so-called enrichment operation in high-load operation, in which a cooling fuel quantity is injected to cool the combustion exhaust gases, the fuel injector being able to be designed with a reduced static flow in relation to conventional fuel injectors.

According to a first aspect, a method is provided for controlling an injection in an internal combustion engine, in particular in a gasoline engine having direct fuel injection. In one working cycle, a drive fuel quantity, which indicates the fuel quantity which is required by the internal combustion engine to provide a desired torque, is injected before a combustion stroke of the working cycle into a cylinder of the internal combustion engine, a cooling fuel quantity, which indicates a fuel quantity which is used for cooling the combustion exhaust gases, being injected in addition to the drive fuel quantity in the working cycle, at least part of the cooling fuel quantity being injected after completion of the combustion in the combustion stroke and/or the immediately following exhaust stroke of the power cycle.

According to an example embodiment of the present invention, the injection of the entire fuel quantity to be injected is divided into two injection time windows. During the first injection time window, which is generally within an intake stroke during which air is sucked into the combustion chamber of the cylinder via an air supply system, a drive fuel quantity, which is required for combustion, i.e., for torque generation, is injected. The second injection time window is within a period of time which begins with the end of combustion and ends before the outlet valve is opened or within a time window during the exhaust stroke during which the outlet valve is opened or within a time window which begins with the combustion stroke and ends with the exhaust stroke. During the second time window, fuel is exclusively injected in a post-injection in a torque-neutral manner for the enrichment operation, i.e., for cooling the combustion exhaust gases. The cooling fuel quantity may be completely injected during the second time window or, alternatively, part of the cooling fuel may be injected during the first injection time window and the remainder may be injected during the second injection time window.

Since the cooling fuel quantity is not required for torque generation, it is noncritical to inject it at least partially after combustion. The cooling fuel quantity, which is required for cooling down the temperature of the combustion exhaust gas, still cools the combustion exhaust gases in the combustion chamber, so that already cooled combustion exhaust gases are expelled in the exhaust stroke. Since the drive fuel quantity to be injected during the intake stroke, which is required for torque generation, is reduced in comparison to typical operation by the cooling fuel component, the fuel quantity thus reduced during the first injection time window may be injected using a lower flow of the fuel injector. The fuel injector may thus be designed in such a way that the static flow at the operating point under full load at rated speed is reduced in relation to typically used fuel injectors. This results in more precise metering of the fuel quantity in the case of operating points having small injection quantities, which may result in improvement of the smooth running and the emissions in the case of operating points of small injection quantities.

Furthermore, the cooling fuel quantity may be injected in a time window between the moment of combustion completion and the beginning of expulsion of combustion exhaust gas from the cylinder.

According to an alternative, the cooling fuel quantity may be injected in a time window between the point in time where the expulsion of the combustion exhaust gas from the cylinder begins and a point in time before the end of the expulsion of the combustion exhaust gas from the cylinder.

As an alternative, the cooling fuel quantity may be injected in a time window between the point in time following the completion of the combustion during the combustion stroke and after the beginning of an expulsion of the combustion exhaust gas from the cylinder during the exhaust stroke.

Furthermore, the beginning of the time window for injecting the cooling fuel quantity as well as the cooling fuel quantity may be ascertained after or when the point in time of ignition for initiating the subsequent combustion has been ascertained.

In particular, the cooling fuel quantity may be established as a function of the operating point, the cooling fuel quantity being injected into an operating range in which the exhaust gas temperature would exceed a temperature threshold value without injection of the cooling fuel quantity. Alternatively, the cooling fuel quantity may be injected as a function of an engine load and/or as a function of a speed of the internal combustion engine.

Furthermore, the cooling fuel quantity and the point in time of the injection of the cooling fuel quantity may be established as a function of an engine load and/or as a function of a speed of the internal combustion engine.

According to one specific embodiment, the part of the cooling fuel quantity which is injected jointly with the drive fuel quantity before the combustion in the cylinder may be metered as a function of an ignition angle, so that knocking of the internal combustion engine is suppressed.

Furthermore, the part of the cooling fuel quantity which is injected jointly with the drive fuel quantity before the combustion in the cylinder may be metered as a function of an occurrence of a knocking event.

According to a further aspect, a control unit is provided for controlling an injection in an internal combustion engine, in particular having direct fuel injection. The control unit is designed to activate a fuel injector of a cylinder in the internal combustion engine so that a drive fuel quantity, which indicates a fuel quantity required by the internal combustion engine to provide a desired torque, is injected in a working cycle before a combustion stroke of the working cycle into a cylinder of the internal combustion engine, and a cooling fuel quantity, which indicates a fuel quantity which is used for cooling the combustion exhaust gases, is injected in the working cycle in addition to the drive fuel quantity, at least part of the cooling fuel quantity being injected after completion of the combustion in the combustion stroke and/or the immediately following exhaust stroke of the working cycle.

According to a further aspect, an example engine system is provided. The example engine system includes:
an internal combustion engine having one or more cylinders;
a fuel injector for injecting fuel into one of the cylinders of the internal combustion engine;
the above-mentioned control unit.

According to a further aspect, an example method for selecting a fuel injector for an engine system is provided. The example method includes the following steps:
providing a rated speed and a maximum drive fuel quantity, which indicates the fuel quantity required by the internal combustion engine at the rated speed to provide a predefined torque;
ascertaining the time duration of the time window which is available for injection of the maximum drive fuel quantity at the rated speed;
selecting the fuel injector having a static flow, which indicates the fuel quantity per unit of time in the case of a completely open fuel injector, the static flow being determined by the time duration of the time window and the maximum drive fuel quantity.

### BRIEF DESCRIPTION OF THE DRAWINGS

Preferred specific embodiments of the present invention are explained in greater detail below on the basis of the figures.

FIG. 1 shows a schematic view of an engine system having an internal combustion engine.

FIG. 2 shows a graph to illustrate the curves of the cylinder pressure, the gas temperature in the cylinder, the valve strokes for the outlet valve and intake valve, and the combustion curve as a function of a crankshaft angle.

### DETAILED DESCRIPTION OF EXAMPLE EMBODIMENTS

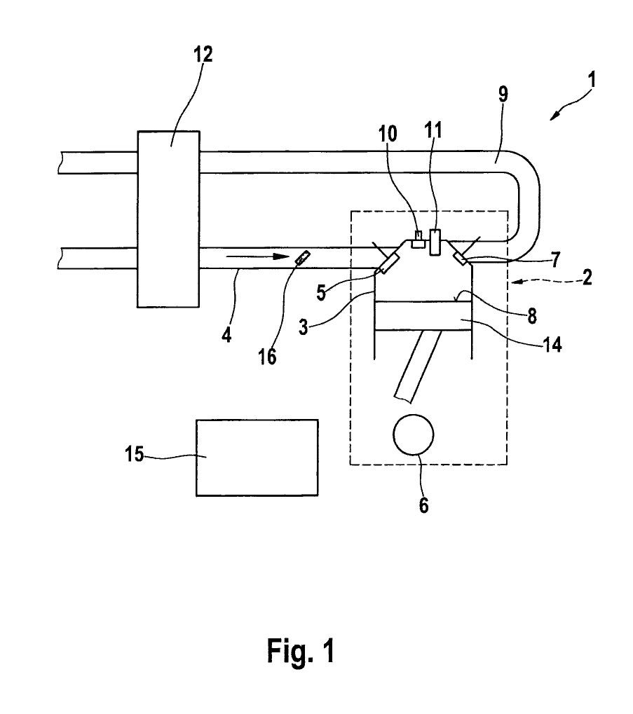

An engine system 1 having an internal combustion engine 2, in particular a gasoline engine, is shown in FIG. 1. Internal combustion engine 2 is shown having only one cylinder 3 for the sake of simplicity; however, the internal combustion engine may have multiple cylinders, which are coupled to one another so that they have offset strokes to one another.

Cylinder 3 is connected to an air supply system 4 and has an intake valve 5. Intake valve 5 may be coupled to a crankshaft 6, in order to let air into a combustion chamber 8 of cylinder 3 during an intake time window controlled by a crankshaft angle of crankshaft 6. Alternatively, conventional electrically controlled intake valves are available.

Furthermore, the cylinder has an outlet valve 7, in order to let combustion gases out of combustion chamber 8 of cylinder 3 into an exhaust system 9. Outlet valve 7 may also be activated either via a position of crankshaft 6 as a function of a crankshaft angle or, alternatively, electrically.

Furthermore, a fuel injector 10 is provided, which is connected to a fuel line (not shown) and which is electrically activatable in order to inject fuel into combustion chamber 8 of cylinder 3 as a function of the corresponding activation. Cylinder 3 also includes an ignition apparatus 11, which is activatable to establish a point in time of ignition. Ignition apparatus 11 generates an ignition spark at a predefinable point in time and thus initiates combustion of the air/fuel mixture in combustion chamber 8.

A turbocharging device 12 is situated in air supply system 4 and in exhaust system 9, which may be implemented in the form of an exhaust gas turbocharger, for example. The exhaust gas turbocharger is driven by the energy of the exhaust gas stream (exhaust gas enthalpy) and is used for the purpose of providing charge air in the air supply system under a charge pressure, in order to increase the air quantity to be conveyed into combustion chamber 8.

Internal combustion engine 2 is operated in four-stroke operation, which is describable by the movement of a piston 14 in cylinder 3. In four sequential working strokes, piston 14 shrinks combustion chamber 8 twice and enlarges combustion chamber 8 twice. In four-stroke operation, air is first sucked in from air supply system 4 in an intake stroke and simultaneously fuel is injected via fuel injector 10 during a first injection time window in order to form an air/fuel mixture. The intake is performed via a movement of piston 14 in cylinder 3, which enlarges combustion chamber 8.

Intake valve 5 is closed near bottom dead center of piston 14, i.e., at the largest possible volume of combustion chamber 8, and a compression stroke begins, which compresses the air/fuel mixture located in combustion chamber 8. The air/fuel mixture is homogenized during the compression stroke.

Near top dead center of the movement of piston 14 in cylinder 3, at which combustion chamber 8 has the smallest volume, the air/fuel mixture is ignited with the aid of ignition apparatus 11 and the combustion stroke follows, during which piston 14 is moved in an expansion movement through the pressure arising from combustion.

Near bottom dead center, outlet valve 7 is opened and the combustion exhaust gas generated by combustion is expelled into exhaust system 9 by an expulsion movement of piston 14 (exhaust stroke), during which combustion chamber 8 is shrunk.

The operation of internal combustion engine 2 is controlled by a control unit 15. In particular, control unit 15 controls the delivery rate of turbocharger 12 (for example, by changing a turbine geometry of a turbine in the exhaust system or setting a waste gate valve in the exhaust system), a position of a throttle valve 16 located in air supply system 4, a position of fuel injector 10, an activation of ignition apparatus 11, and the like in a known way in order to operate internal combustion engine 2.

In full-load operation or in general in the case of operating states in which combustion exhaust gases having a high temperature arise, a measure must be performed to cool the combustion exhaust gases. One possibility for cooling the combustion exhaust gases is to inject additional fuel, so that during the expulsion of the combustion exhaust gases in the exhaust stroke, the exhaust gas temperature is reduced by the intrinsic temperature of the additional fuel and due to the vaporization of the additional fuel. Such a mode of operation is referred to as an enrichment mode of operation, because internal combustion engine 2 is operated overall using an excessively rich air/fuel mixture.

The fuel quantity which is used for cooling the combustion exhaust gases is referred to herein as the cooling fuel quantity, while the fuel quantity which is injected to provide the drive torque of the internal combustion engine is referred to as the drive fuel quantity.

The entire fuel quantity is typically injected into combustion chamber 8 of cylinder 3 in the first injection time window during the intake stroke. This first injection time window has a dimension of approximately a crankshaft angle range from 150° to 200° and ends approximately 180° before top dead center of piston 14 which follows the compression stroke. Since the enrichment operation for cooling the combustion exhaust gas typically occurs in high-load operation, a particularly high fuel quantity to be injected may be required. Therefore, in a typical engine system 1, fuel injector 10 is designed in such a way that the entire fuel quantity may be injected during the injection time window. The limited length of the injection time window results in a required static flow of fuel injector 10.

The injection may be controlled with the aid of control unit 15 in such a way that the injection of at least part of the cooling fuel quantity is performed in a second injection time window which is different from the first injection time window. The time range which, in principle, may include the second injection time window begins immediately after the end of the combustion procedure, which is ascertainable via a combustion curve calculation, for example, during the combustion stroke and ends at a point in time in the exhaust stroke where it is ensured that the injected cooling fuel quantity may be completely expelled by the piston stroke into the exhaust train. There are several possibilities. First, the time period containing the second injection time window may be included completely within the combustion stroke. Second, there is a possibility that the second injection time window may be completely within the exhaust stroke, the injection taking place in such a way that it is ensured that the injected cooling fuel quantity is expelled completely into the exhaust train. Third, there is a possibility of setting the time window in such a way that it starts within the combustion stroke and ends in the exhaust stroke.

Altogether, in this way, the entire fuel quantity to be injected into combustion chamber 8 during the first injection time window may be reduced, so that the maximum fuel flow through fuel injector 5 is reduced. This allows a reduction in the dimension of fuel injector 5 to lower static flow quantities.

In the second injection time window, part or all of the cooling fuel quantity may be injected. It may be advisable to inject part of the cooling fuel quantity during the first injection time window jointly with the drive fuel quantity and to inject the remaining component during the second injection time window. Knocking of internal combustion engine 2 may thus be suitably suppressed.

The location of the second injection time window is preferably determined after determining the point in time for ignition of the ignition device in the cylinder. This allows the changes that may still occur during dynamic operation of the internal combustion engine between fuel injection and the determination of the point in time of ignition and which are taken into account when the points in time of ignition are determined, to be taken into account when determining the length and point in time for the second injection time window.

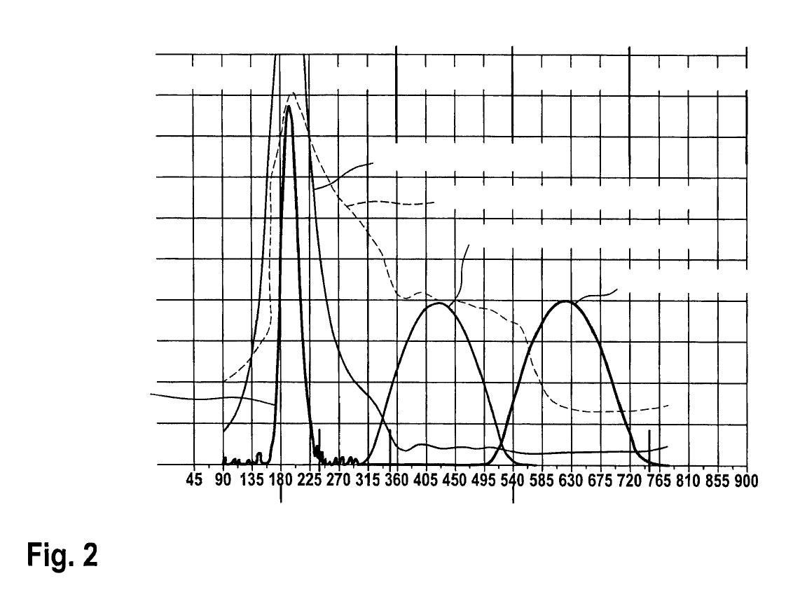

The location of the injection time window is illustrated, as an example, in the graph of FIG. 2. The graph of FIG. 2 qualitatively shows the curves of the valve strokes of intake valve 5 and outlet valve 7, the curve of the gas temperature in cylinder 3, the curve of the cylinder pressure, and the combustion curve over the entire crankshaft angle range of 720° (90° to 810°).

In the case of the design of a fuel injector 10 for an engine system 1, in which internal combustion engine 2 is operated using the above-described method, fuel injector 10 may be designed in such a way that its static flow rate Qₛₜₐₜ_{_{—}}_{new} results as follows:

Qₛₜₐₜ_{_{—}}_{new}=Qₛₜₐₜ_{_{—}}_{old}*(1−m_{enrichment}/(mₘₐᵢₙ_{_{—}}_{injection}+m_{enrichment})),

Qₛₜₐₜ_{_{—}}_{new} corresponding to the flow rate of fuel injector 10 to be dimensioned, Qₛₜₐₜ_{_{—}}ₐₗₜ corresponding to the static flow rate of a fuel injector in which the injection may be performed completely during the intake stroke, m_{enrichment} corresponding to the cooling fuel quantity required for the enrichment in enrichment operation, and mₘₐᵢₙ_{_{—}}_{injection} corresponding to the drive fuel quantity in the case of the full-load operating point at rated speed. In the case of an enrichment by 30%, for example, the static flow rate may thus be reduced by 23% in the case of a fuel injector in an engine system which is operated according to the above-described method.

What is claimed is:

1. A method for controlling an injection of fuel in an internal combustion engine having direct injection, comprising:
injecting a drive fuel quantity, which indicates a fuel quantity required by the internal combustion engine to provide a desired torque, in a working cycle before a combustion stroke of the working cycle into a cylinder of the internal combustion engine; and
injecting a cooling fuel quantity, which indicates a fuel quantity which is used to cool combustion exhaust gases, in the working cycle in addition to the drive fuel quantity;
wherein at least part of the cooling fuel quantity is injected one of after completion of combustion in the combustion stroke, and in an immediately following exhaust stroke of the working cycle.

2. The method as recited in claim 1, wherein the cooling fuel quantity is injected in a time window which is between a point in time following the completion of the combustion and a beginning of an expulsion of combustion exhaust gas from the cylinder.

3. The method as recited in claim 1, wherein the cooling fuel quantity is injected in a time window between a point in time where an expulsion of the combustion exhaust gas from the cylinder begins and a point in time before an end of the expulsion of the combustion exhaust gas from the cylinder.

4. The method as recited in claim 1, wherein the cooling fuel quantity is injected in a time window between a point in time following a completion of the combustion during the combustion stroke and after expulsion of the combustion exhaust gas from the cylinder begins during the exhaust stroke.

5. The method as recited in claim 1, wherein a beginning of a time window for injecting the cooling fuel quantity and the cooling fuel quantity are ascertained one of after or when a point in time of ignition for initiating subsequent combustion has been determined.

6. The method as recited in claim 1, wherein the cooling fuel quantity is established as a function of at least one of an engine load and a speed of the internal combustion engine.

7. The method as recited in claim 1, wherein the cooling fuel quantity is injected in an operating range of the internal combustion engine in which an exhaust gas temperature would exceed a temperature threshold value without injection of the cooling fuel quantity.

8. The method as recited in claim 7, wherein a point in time of the injection of the cooling fuel quantity is established as a function of at least one of an engine load and a speed of the internal combustion engine.

9. The method as recited in claim 8, wherein a part of the cooling fuel quantity which is injected jointly with the drive fuel quantity before the combustion in the cylinder is metered as a function of an ignition angle so that knocking of the internal combustion engine is suppressed.

10. The method as recited in claim 1, wherein a part of the cooling fuel quantity which is injected jointly with the drive fuel quantity before the combustion in the cylinder is metered as a function of an occurrence of a knocking event.

11. A control unit for controlling an injection in an internal combustion engine having direct injection, the control unit adapted to activate a fuel injector of a cylinder in the internal combustion engine so that a propulsion fuel quantity, which indicates the fuel quantity required by the internal combustion engine to provide a desired torque, is injected in a working cycle before a combustion stroke of a working cycle into a cylinder of the internal combustion engine, and a cooling fuel quantity, which indicates a fuel quantity, which is used to cool the combustion exhaust gases, is injected in the working cycle in addition to the propulsion fuel quantity, at least part of the cooling fuel quantity being injected at least one of after completion of combustion in the combustion stroke and in an immediately following exhaust stroke of the working cycle.

12. An engine system, comprising:
an internal combustion engine having at least one cylinder;
at least one fuel injector to inject fuel into one of the cylinders of the internal combustion engine; and
a control unit for controlling an injection in the internal combustion engine, the control unit adapted to activate a fuel injector of a cylinder in the internal combustion engine so that a propulsion fuel quantity, which indicates the fuel quantity required by the internal combustion engine to provide a desired torque, is injected in a working cycle before a combustion stroke of the working cycle into a cylinder of the internal combustion engine, and a cooling fuel quantity, which indicates a fuel quantity which is used to cool the combustion exhaust gases, is injected in the working cycle in addition to the propulsion fuel quantity, at least part of the cooling fuel quantity being injected at least one of after completion of combustion in the combustion stroke and in an immediately following exhaust stroke of the working cycle.

13. A method for selecting a fuel injector for an engine system made of multiple fuel injectors and an internal combustion engine, comprising:
providing a specification of a rated speed and a specification of a maximum drive fuel quantity which indicates a fuel quantity required by the internal combustion engine at the rated speed to provide a predefined maximum torque;
ascertaining a time duration of a time window which is available for an injection of the maximum drive fuel quantity at the rated speed; and
selecting the fuel injector so that the fuel injector at least has a static flow which indicates a fuel quantity flowing through the fuel injector per unit of time in a case of completely open fuel injector, the static flow being determined by the time duration of the time window and the maximum drive fuel quantity.
